(19) United States
(12) Patent Application Publication
(10) Pub. No.: US 2008/0294482 A1
(43) Pub. Date: Nov. 27, 2008

(54) Personalized Electronic Meeting Invitations

(75) Inventors: Judith H. Bank, Morrisville, NC (US); Lisa M. Bradley, Cary, NC (US); Belinda Ying-Chieh Chang, Cary, NC (US); Tamera L. Davis, Raleigh, NC (US); Lin Sun, Morrisville, NC (US); Chunhui Yang, Durham, NC (US)

Correspondence Address: MARCIA L. DOUBET LAW FIRM, PO BOX 422859, KISSIMMEE, FL, 34742, US

(73) Assignee: International Business Machines Corporation, Armonk, NY (US)

(21) Appl. No.: 11/753,992

(22) Filed: May 25, 2007

(51) Int. Cl. G06Q 10/00; G06F 17/40

(52) U.S. Cl. 705/8; 707/104.1

(57) ABSTRACT

Personalized meeting invitations, which may be used by electronic calendar applications (which may also be referred to as “calendar applications”, “calendaring applications”, or “calendar scheduling systems”). Using techniques disclosed herein, a meeting can be conceptually viewed as multiple smaller meetings, which are also referred to herein as “submeetings”, and a personalized meeting invitation sent to each invitee reflects that invitee's required presence at the meeting or an individual submeeting thereof. Optionally, personalized meeting invitations may also be used for invitees whose presence at a submeeting is optional. When an invitee accepts a personalized meeting invitation, the submeeting is placed on the invitee's electronic calendar, showing the invitee as unavailable during the corresponding time slot for the submeeting. Other people viewing the invitee's calendar can then see an accurate view of the invitee's availability.

### BACKGROUND OF THE INVENTION

The present invention relates to computer programming, and deals more particularly with personalized meeting invitations for electronic calendar applications (or similar applications such as electronic scheduling applications).

Electronic calendar applications are used extensively in many people's daily work. Electronic calendars often contain a wealth of information about their owner. For example, an individual may use an electronic calendar to maintain information about his work schedule, his meetings and other appointments, his vacation and business travel plans (including when he will be away, which flights or other transportation he will use, where he can be reached while away, who he may visit while away, etc.), phone calls that need to be made at particular times, and so forth. Examples of electronic calendar systems include Microsoft Outlook® and Lotus Notes®, which also allows a user to create entries on his calendar for other people. For example, a secretary might have calendar entries for his own schedule, but also keep information about his manager's appointments on his manager's calendar (and optionally his own calendar as well). Such systems are quite popular among users. (“Outlook” is a registered trademark of Microsoft Corporation, and “Lotus Notes” is a registered trademark of Lotus Development Corporation.)

### BRIEF SUMMARY OF THE INVENTION

The present invention is directed to personalized meeting invitations for a meeting comprising a plurality of submeetings. In one embodiment, this comprises: identifying, for each of the submeetings, each invitee invited to attend the submeeting; identifying, for each of the submeetings, a time period corresponding to the submeeting; and generating a personalized meeting invitation for each of the invitees, wherein the personalized meeting invitation corresponds to the submeeting which the invitee is invited to attend and reflects the time period corresponding to the submeeting.

In another embodiment, the present invention is directed to a personalized meeting invitation system in a computing environment connected to a network, comprising: a meeting scheduler for scheduling a meeting, the meeting comprising a plurality of submeetings to which at least one invitee is invited to attend, each submeeting corresponding to a time period within an overall time period of the meeting; persistent storage for storing, for each of the submeetings, an identification of at least one invitee invited to attend the submeeting; a personalized meeting invitation generator for generating a personalized meeting invitation to invite each of the invitees to attend each of the submeetings during the corresponding time period for that submeeting; and an invitation sender for sending the generated personalized meeting invitations to each of the invitees.

In yet another embodiment, the present invention is provided as a computer program product for personalizing electronic meeting invitations for a meeting comprising a plurality of submeetings, the computer program product embodied on one or more computer-usable media and comprising computer-readable program code for: identifying, for each of the submeetings, each invitee invited to attend the submeeting, wherein at least one of the invitees is invited to attend more than one of the submeetings; identifying, for each of the submeetings, a time period corresponding to the submeeting; and generating a personalized meeting invitation for each of the invitees, wherein: the personalized meeting invitation corresponds to the submeeting which the invitee is invited to attend and reflects the time period corresponding to the submeeting; and a separate personalized meeting invitation is generated for each of the at least one invitees invited to attend more than one of the submeetings.

Embodiments of these and other aspects of the present invention may also, or alternatively, be provided as systems or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

The present invention will be described with reference to the following drawings, in which like reference numbers denote the same element throughout.

### BRIEF DESCRIPTION OF THE SEVERAL VIEWS OF THE DRAWINGS

FIG. 1 illustrates a graphical user interface (“GUI”) for scheduling a meeting using an electronic calendar application, according to the prior art;

FIG. 2 illustrates a “submeeting” concept, referring to a hypothetical meeting that comprises a plurality of submeetings, and FIG. 3 illustrates multiple meeting invitations that are generated for the submeetings of this hypothetical meeting;

FIG. 4 shows an example of a data structure that may be used for information pertaining to submeetings, according to an embodiment of the present invention;

FIG. 5 shows a sample GUI from which personalized meeting invitations may be generated;

FIG. 6 provides a flowchart depicting logic which may be used when implementing an embodiment of the present invention;

FIG. 7 provides a sample markup language document fragment, showing one manner in which submeeting information may be represented, according to an embodiment of the present invention;

FIG. 8 depicts a data processing system suitable for storing and/or executing program code; and

FIG. 9 depicts a representative networking environment in which one or more embodiments of the present invention may be used.

### DETAILED DESCRIPTION OF THE INVENTION

Embodiments of the present invention are directed toward personalized electronic meeting invitations, where such meeting invitations may be used by electronic calendar applications (which may also be referred to as “calendar applications”, “calendaring applications”, or “calendar scheduling systems”). Using techniques disclosed herein, a meeting can be conceptually viewed as multiple smaller meetings, which are also referred to herein as “submeetings”, and a personalized meeting invitation sent to each invitee will correctly reflect that invitee's required presence at the meeting or an individual submeeting thereof. For an invitee who is invited to more than one submeeting, one embodiment of the present invention creates and sends a personalized meeting invitation for each of the multiple submeetings.

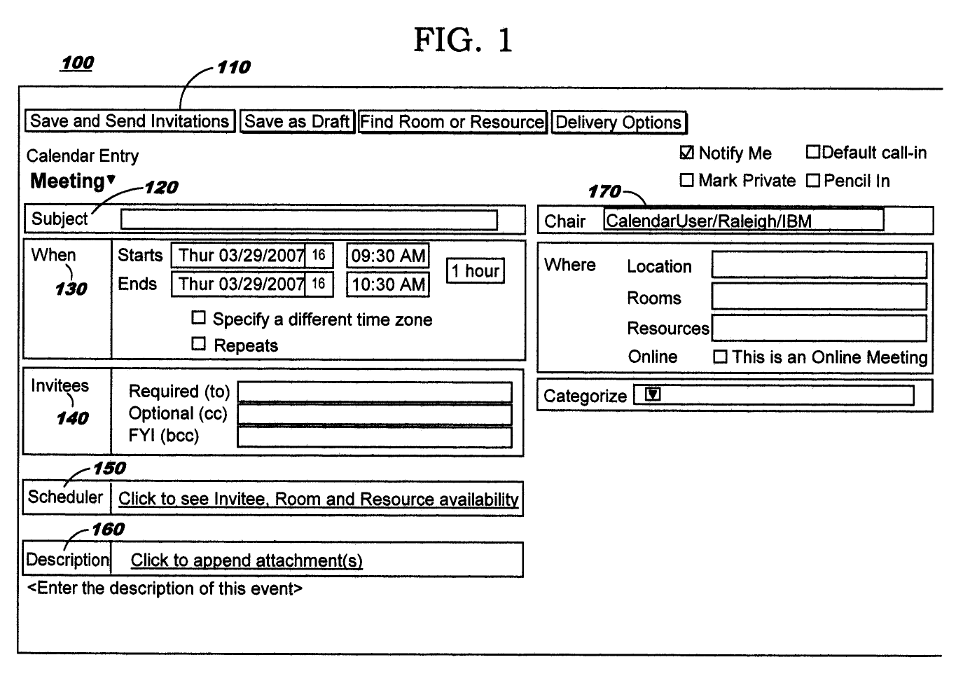

In most business environments, scheduling and attending meetings is inevitable. Electronic calendar applications are commonly used to generate meeting invitations. A commonly-used technique for scheduling meetings will now be described with reference to FIG. 1.

A person who is referred to herein as a “meeting originator” commonly uses an electronic calendar application to schedule a meeting with other people, and these other people are referred to herein as “meeting attendees” or “invitees”. See example GUI 100 of FIG. 1, illustrating information that may be provided by a meeting originator when scheduling a meeting using an electronic calendar application. A subject 120 for the meeting is typically specified, as well as the meeting date and time 130. A more detailed meeting description may also be specified, if desired (see 160). The meeting originator creates (or retrieves) an invitation list (see 140), and a calendar application may then use this list to check each invitee's electronic calendar for available time periods (as indicated generally at 150). A meeting may then be scheduled during a time period in which all (or some majority) of the invitees have sufficient time available on their calendar. When the meeting originator (identified in GUI as the meeting “chair”; see 170) indicates that the information is complete (e.g., by clicking on the “Save and Send Invitations” graphical button 110), the underlying electronic calendar application then notifies the invitees, typically by sending an email message to each of the invitees. Use of electronic calendar applications for scheduling meetings of multiple persons in this manner is known in the art.

Scheduling meetings may take a considerable amount of time, in particular for meeting originators who must schedule a number of meetings. Often times, a meeting originator needs to schedule multiple meetings for multiple events, where those events are related in some manner. For example, a manager may want to schedule so-called “one-to-one” meetings with each employee in the manger's department, where each such one-to-one meeting will be attended by the manager and one of the employees. It can be time-consuming and tedious to individually schedule each of these one-to-one meetings, especially if the department has a large number of employees.

Or, it may happen that a number of people are invited to attend a particular meeting, but not all of these people need to be present for the entire duration of the meeting. For example, if multiple people are working on a large group project, it may be desirable to schedule a project status meeting where status of the overall project is discussed in terms of individual components of the project. In that case, the meeting originator may wish to schedule a separate discussion for each component, and invite the people who are working on that component to attend the project status meeting only while their component is being discussed. It can be time-consuming and tedious if the meeting originator has to manually schedule each individual time period as a separate meeting and send out a separate meeting invitation to the people whose presence is needed for that particular time period.

In scenarios such as these, one prior art approach is for the meeting originator to block out a time interval that spans the entire meeting duration. The manager who schedules one-to-one meetings with employees, for example, may save time by scheduling a meeting for an entire day in which the manager will meet with one employee during each half-hour time slot. In this approach, the meeting is scheduled to start when the first employee session begins and to end when the last employee session is finished. Or, the meeting originator who schedules the project status meeting may save time by scheduling one meeting with a duration that encompasses the discussions of all of the project components.

While this approach saves time for the meeting originator, the meeting invitees receive invitations that do not properly represent that invitee's time commitment for the meeting. That is, if the meeting invitees receive an invitation for the entire meeting duration, their electronic calendars will show them as being unavailable for the entire duration, even though they might only need to attend the meeting for some subset of that duration.

Techniques disclosed herein enable a meeting originator to create multiple meeting invitations from a meeting notice, where those meeting invitations are personalized meeting invitations that represent the time slot (which may alternatively be referred to as a “time period”) for which the meeting invitee is invited during the overall meeting, without having to manually create and send separate meeting invitations for each submeeting. The time slot and required attendees for that time slot (and, optionally, other relevant information) are specified. The personalized meeting invitations are sent out with this information, and reflect the information for that part of the meeting for which each invitee is required to attend. When an invitee accepts a personalized meeting invitation, the submeeting is placed on the invitee's electronic calendar, showing the invitee as unavailable during the corresponding time slot for the submeeting. Other people viewing the invitee's calendar can then see an accurate view of the invitee's availability: time periods that would be erroneously shown as unavailable when using a prior art approach that blocks out the entire meeting duration (and therefore incorrectly shows the invitee as unavailable for the entire meeting duration) can then be shown as free (i.e., unscheduled) time when using personalized meeting invitations. Personalized meeting invitations may also be used for invitees whose presence at a submeeting is optional, as will be discussed herein.

According to an embodiment of the present invention, the meeting originator uses an electronic calendar application to create a meeting invitation, where the meeting may be conceptually viewed as multiple meeting subsets or multiple submeetings. In one approach, the meeting originator first specifies the starting and ending time of the overall meeting and identifies each invitee who is required to attend the entire meeting. These identified invitees will receive an invitation that corresponds to the entire meeting; upon accepting the meeting invitation, the entire meeting duration will be blocked out on the invitee's electronic calendar as unavailable (i.e., already-scheduled) time. (It may happen that the meeting originator, who may alternatively be referred to as the meeting chairperson, is the only person who is required to attend the entire meeting, in which case other invitees are not necessarily identified at this stage.) By contrast, invitees who are invited to attend a submeeting will receive a meeting invitation reflecting only a subset of the meeting duration, as will be described in more detail herein.

In an optional aspect, the meeting originator is allowed to specify whether submeeting information is visible to invitees who are invited to any submeeting of the overall meeting, or only to the invitees of that particular submeeting. In the former case, all of the invitees can see submeeting information, even though they might not be attending all of the submeetings. This may be beneficial, for example, to give the invitees a view of the overall meeting agenda. In the latter case, meeting invitees can see only the meeting information for the submeeting(s) to which they are invited. This may be beneficial, for example, if confidential or sensitive topics are scheduled for a submeeting.

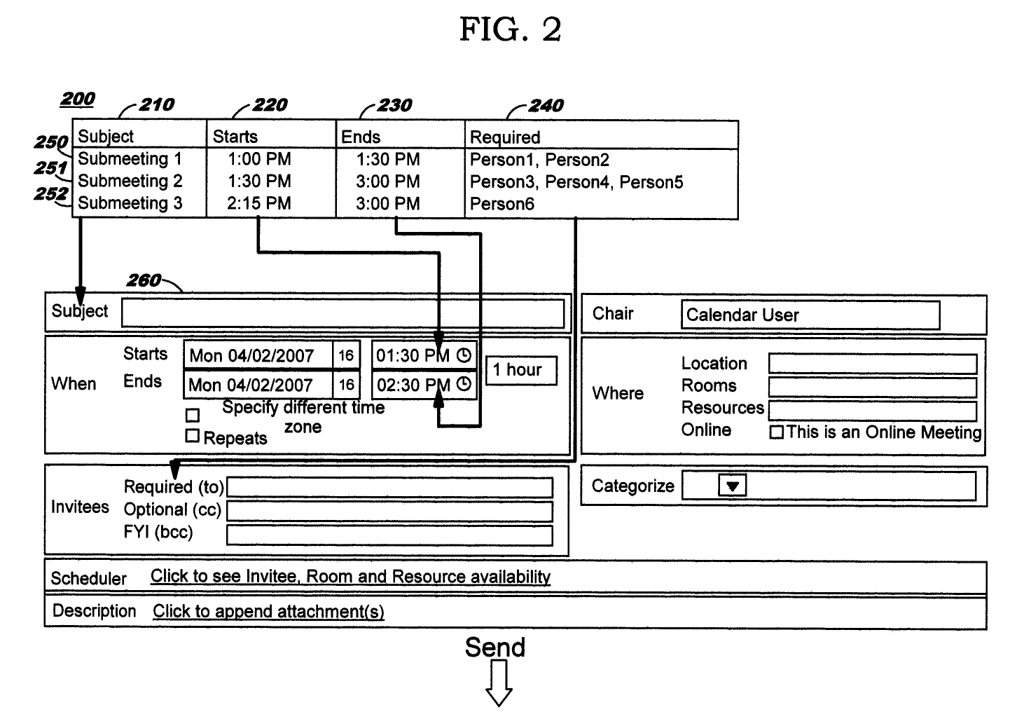

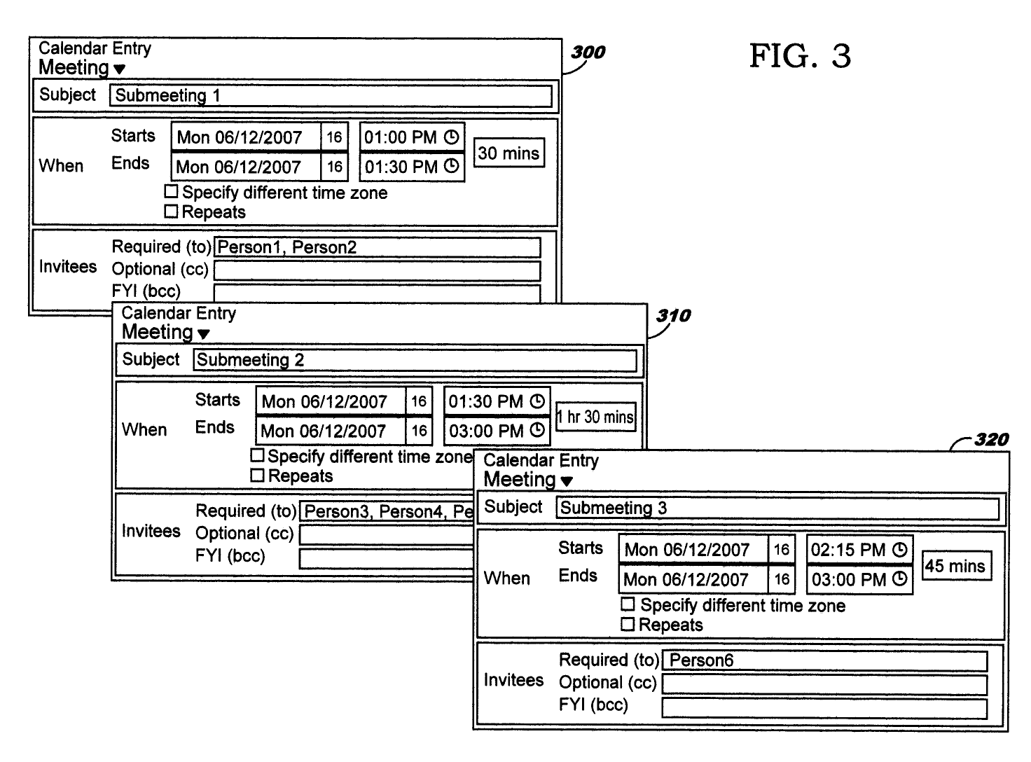

FIG. 2 illustrates the submeeting concept, at an abstract level, for a hypothetical meeting. As shown therein by box 200, a meeting subject may be considered as comprising multiple submeeting subjects (see 210), with each submeeting having its own starting and ending times (see 220 and 230, respectively) and its own list of required invitees (see 240). In some cases, the time slot for one submeeting may overlap the time slot of another submeeting, as shown for the submeetings in rows 251, 252. (Note that the underlying calendar GUI 260 does not correspond, in this conceptual illustration, to the submeetings that are represented in box 200.)

FIG. 3 illustrates creating and sending multiple personalized meeting invitations, one for each of the submeetings represented by box 200 of FIG. 2. In these sample personalized meeting invitations, the subject and duration of each submeeting is specified, and the invitees for each submeeting are identified. In meeting invitation 300, for example, the subject is shown as “Submeeting 1”; the starting time is 1:00 PM; the ending time is 1:30 PM; and the required meeting attendees are “Person1, Person2”. This meeting invitation corresponds to row 250 in box 200 of FIG. 2. Similarly, meeting invitation 310 corresponds to row 251, and meeting invitation 320 corresponds to row 252.

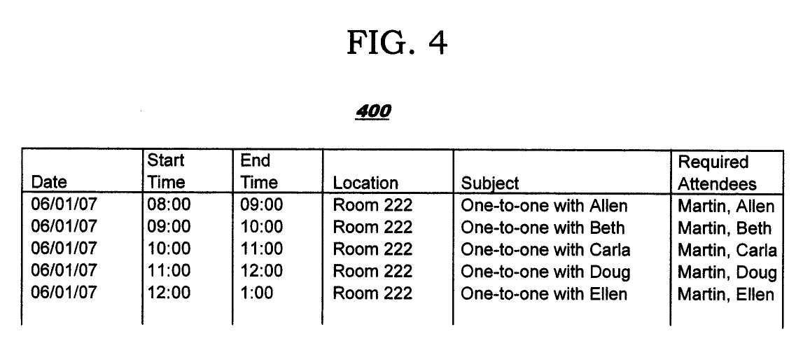

In one approach, a meeting originator creates a data structure, which is referred to herein as a table (by way of illustration but not of limitation), to store information pertaining to submeetings of a meeting. This is illustrated in FIG. 4. In this sample table 400, column headings are shown that correspond to fields containing information usable for creating a calendar entry on the electronic calendar of a meeting invitee. These fields may comprise, by way of example, the submeeting date, the starting and ending time of the submeeting, the location and subject of the submeeting, and an identification of the required attendees of the submeeting. The rows in table 400, in this example, provide information for scheduling one-to-one (sub)meetings between a manager “Martin” and 5 of his employees. Using techniques disclosed herein, Martin schedules this meeting to start at 8:00 a.m. and to end at 1:00 p.m., resulting in the corresponding 5-hour time period being blocked out as unavailable on Martin's own electronic calendar. By contrast, each of the 5 employees will have only their corresponding 1-hour submeeting blocked out as unavailable on their own electronic calendar when they accept the personalized meeting invitation that corresponds to their submeeting. (It will be understood that this example table 400 is merely illustrative, and that additional or different fields may be used without deviating from the scope of the present invention. As one example, a field may be added to specify invitees whose presence at the submeeting is optional. As another example, a field may be added to specify the agenda of the entire meeting.)

This table 400 may be created by the meeting originator in various ways, without deviating from the inventive concepts disclosed herein. As one example, the meeting originator creates table 400 using a spreadsheet application. In this case, the table may be stored separately from information used by the electronic calendar application and information stored therein may be retrieved for use by the electronic calendar application. As another example, the meeting originator creates table 400 using an electronic calender application that has been augmented with functionality that supports personalized meeting invitations as disclosed herein. In this case, the table may be integrated with other data used by the electronic calender application (e.g., as part of a calendar database). As yet another example, the meeting originator creates table 400 using a text editor or word processing application.

As will be obvious to one of skill in the art, the column headings are not strictly required to be stored with the table. As one alternative, the electronic calendar application may be configured to locate particular values at a particular offset within each row of the table. As another alternative, when table 400 is created using functionality that is external from the electronic calendar application, the fields of the table may be tagged with identifiers or values that enable the electronic calendar application to determine what type of information is present at which locations within the table, such that the electronic calendar application can then retrieve the appropriate field values for building the personalized meeting invitations for the submeetings. Embodiments of the present invention then use the retrieved information to build the personalized meeting invitations, after which the invitations are sent to the associated meeting invitees.

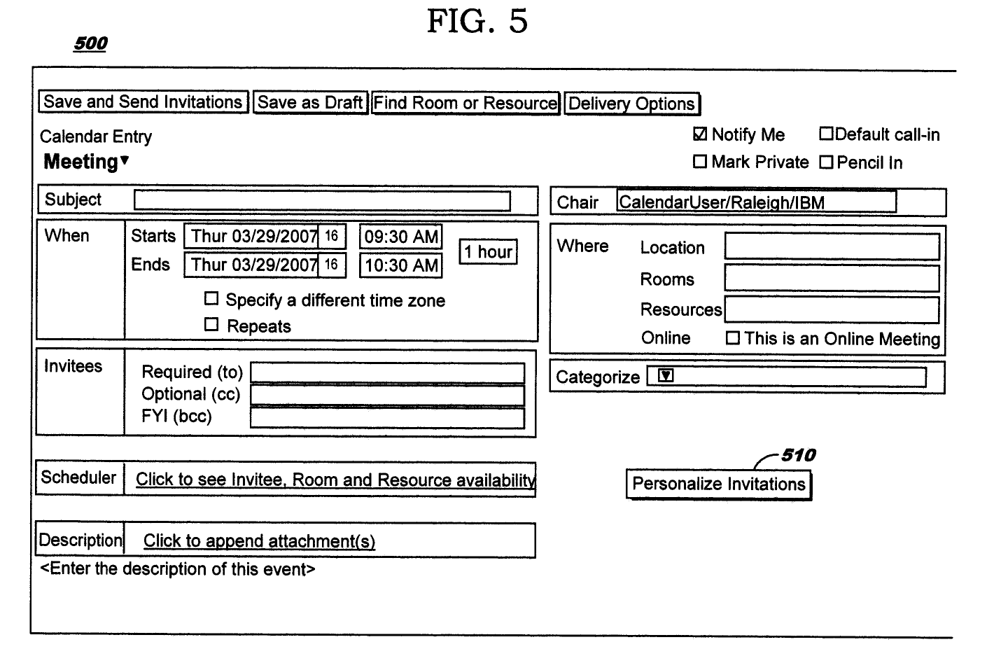

FIG. 5 shows a sample GUI 500 from which personalized meeting invitations may be generated. In this sample GUI, a graphical button 510 is provided (which, by way of illustration only, is labeled “Personalize Invitations”), and responsive to the meeting originator pressing button 510, the electronic calendar application invokes functionality to locate and process submeeting information of the type depicted in FIG. 4. In one approach, pressing button 510 activates a “browse”-type function that allows the meeting originator to identify a location where the submeeting table is persistently stored, at least temporarily, in the local file system (or, alternatively, in other persistent storage, which may include network-accessible storage locations). In one approach, once the submeeting table is located, the meeting originator may be allowed to verify the table contents, for example by opening a viewer that shows the values in the fields of the table. When the meeting originator indicates that he or she is ready to send the personalized meeting invitations for the submeetings (e.g., by pressing a “Send” button), personalized meeting invitations are sent to the invitees of each of the submeetings.

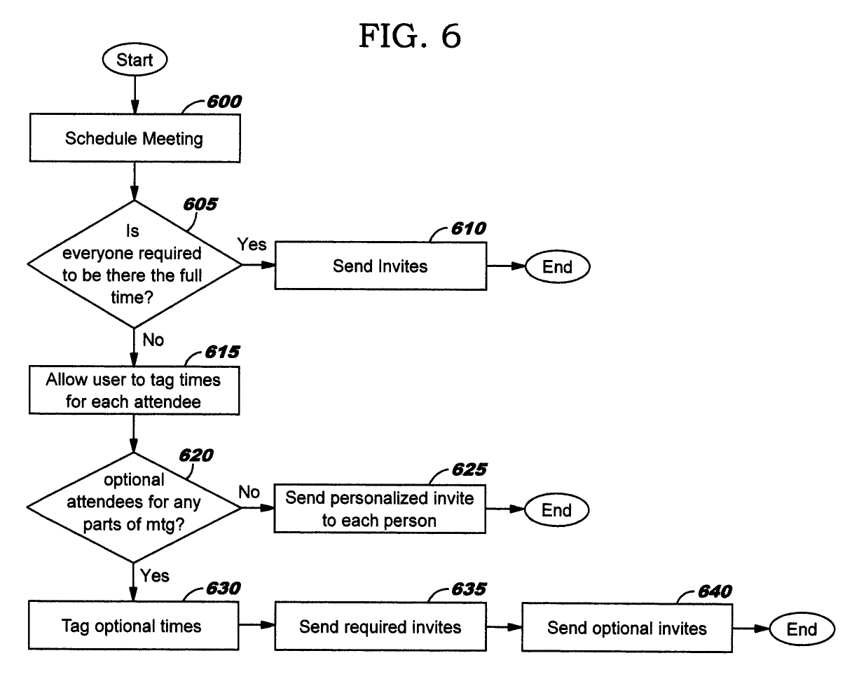

Turning now to FIG. 6, a flowchart is provided that depicts logic which may be used when implementing an embodiment of the present invention. The processing shown in FIG. 6 begins when a meeting originator creates a meeting notice for a meeting that may be structured as multiple submeetings (Block 600). Block 605 asks whether all of the meeting invitees are required to be there for the full time (i.e., for the entire meeting). If so, then a meeting invitation reflecting the entire meeting duration is sent to each invitee (Block 610), and the processing of FIG. 6 ends.

When the test in Block 605 has a negative result (that is, the meeting invitees are not all required to attend the entire meeting), processing reaches Block 615 where an embodiment of the present invention allows the meeting originator to “tag” the times for which each invitee is required to attend the meeting. (This has been discussed above in terms of identifying the times of the submeetings and the invitees of the submeetings.)

Block 620 then asks whether there are optional attendees for any parts of the meeting (i.e., for any of the submeetings). If not, then at Block 625, personalized meeting invitations are sent to the meeting invitees for each submeeting, and the processing of FIG. 6 then ends. Otherwise, when the test in Block 620 has a positive result, then Block 630 indicates that the meeting originator tags the times for which an invitee may optionally attend the meeting. A list may be created, for example, to specify the invitees whose presence is optional during each submeeting, where this list is associated with the corresponding submeeting. Refer also to the discussion of FIG. 4, above, where an optional field for identifying optional invitees was discussed.

Personalized meeting invitations are sent to each invitee whose presence is required (Block 635) for each of the submeetings, and also to each invitee whose presence is optional (Block 640) for the submeetings. The processing of FIG. 6 then ends.

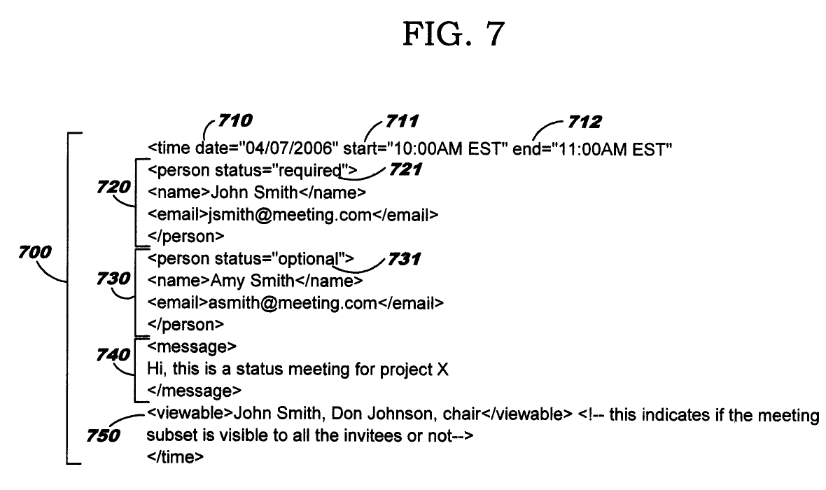

In one embodiment, when a personalized meeting invitation is sent to a meeting invitee, it identifies the time period of the submeeting for which this particular invitee in invited and (optionally) it may also identify the time period of the overall meeting. If a particular invitee is invited to attend multiple submeetings, a separate personalized meeting invitation is preferably generated and sent for each submeeting. This approach facilitates proper scheduling on the invitee's electronic calendar if there are intervening submeetings for which the invitee is not required to attend, and facilitates receiving and processing the personalized meeting invitations with existing calendar application clients. One manner in which additional submeeting information may be represented for a personalized meeting invitation is through use of a markup language document that is associated with the meeting invitation. FIG. 7 illustrates a sample markup language document fragment 700, which in this example (by way of illustration but not of limitation) uses the Extensible Markup Language (“XML”) notation, as will now be discussed.

The <time> element shown in FIG. 7 specifies information for a particular submeeting, and specifies the date and the starting and ending time for this submeeting. See attributes 710-712. The <person> elements 720, 730 each identify an invitee of this submeeting, and in this example, provide the invitee's name and email address using <name> and <email> elements. A “status” attribute may be used, as shown at 721 and 731, to specify whether this invitee's presence for this submeeting is required (see 721) or optional (see 731). Optionally, a <message> element may be used to specify a message from the meeting originator. As another option (not illustrated in FIG. 7), a meeting agenda may be included (for example, by including an <agenda> element) to allow the invitees to see the meeting agenda, as has been discussed earlier.

In an optional enhancement, as discussed above, the meeting originator may specify whether or not each meeting invitee can view information for meeting subsets to which this invitee has not been invited. In one approach, the meeting originator provides a list of those meeting invitees who are allowed to view information about each individual submeeting. Element 750 of FIG. 7 provides a <viewable> element that may be used for this purpose, and in this example, the information specified therein lists the person who is named as a required attendee at 720, a person named “Don Johnson” (who is not listed in <time> element 700 as either a required or optional invitee of this particular submeeting), and generically identifies the chairperson of the meeting (i.e., using the syntax “chair”). Additional or different information may be provided without deviating from the scope of the present invention.

Optionally, an embodiment of the present invention uses techniques disclosed herein to consolidate mass changes to a meeting's invitations. If adjustments need to be made after meeting invitations have already been sent out, for example, the meeting originator can modify information (such as the meeting location, date, or time) from the original meeting notice from which the personalized meeting invitations were created. Accordingly, updated personalized meeting invitations are generated for the submeetings affected by the change, and these updated personalized meeting invitations are sent to the affected meeting invitees. This may be done, for example, by updating information stored in the data structure illustrated by table 400 of FIG. 4 and then using the changed fields of this updated data structure. By contrast, when using a prior art approach where a meeting originator manually schedules submeetings as separate meetings, changes of this type require updating each separately-scheduled meeting.

While embodiments of the present invention have been described herein primarily with reference to electronic calendar applications, this is by way of illustration and not of limitation. In one other approach, a separate application may be used for creating the submeeting information (an example of which is depicted in FIG. 4), and/or a separate application may be used for creating and sending the personalized meeting invitations.

As will be appreciated by one of skill in the art, embodiments of the present invention may be provided as (for example) methods, systems, and/or computer program products. The invention can take the form of an entirely hardware embodiment, an entirely software embodiment, or an embodiment containing both hardware and software elements. In a preferred embodiment, the invention is implemented in software, which includes (but is not limited to) firmware, resident software, microcode, etc. Furthermore, the present invention may take the form of a computer program product which is embodied on one or more computer-usable storage media (including, but not limited to, disk storage, CD-ROM, optical storage, and so forth) having computer-usable program code embodied therein, where this computer program product may be used by or in connection with a computer or any instruction execution system. For purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (“RAM”), a read-only memory (“ROM”), a rigid magnetic disk, and an optical disk. Current examples of optical disks include compact disk read-only memory (“CD-ROM”), compact disk read/write (“CD-R/W”), and DVD.

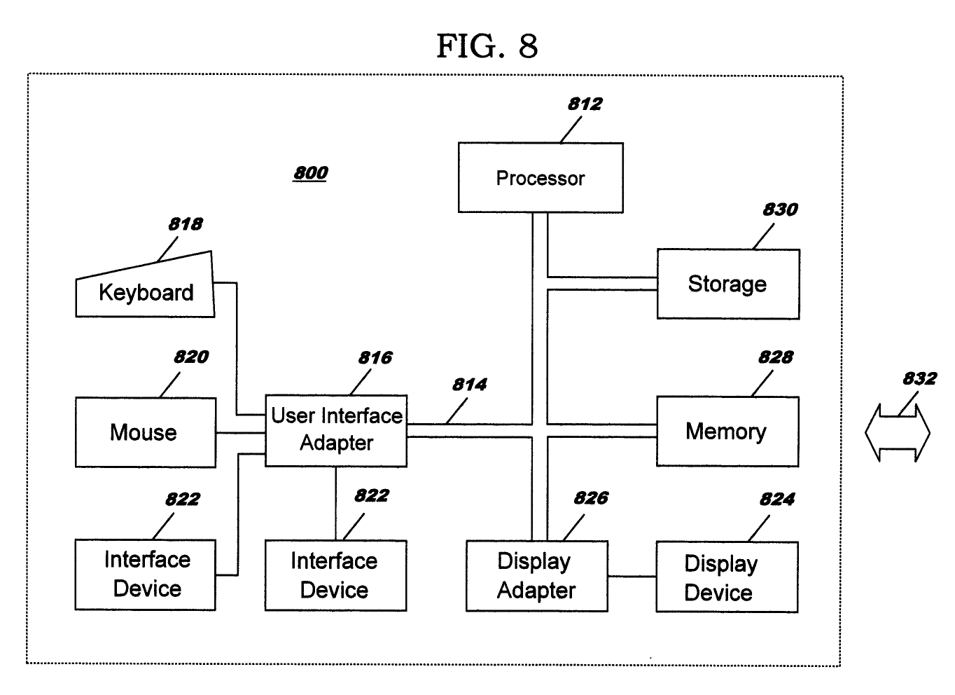

Referring now to FIG. 8, a data processing system 800 suitable for storing and/or executing program code includes at least one processor 812 coupled directly or indirectly to memory elements through a system bus 814. The memory elements can include local memory 828 employed during actual execution of the program code, bulk storage 830, and cache memories (not shown) which provide temporary storage of at least some program code in order to reduce the number of times code must be retrieved from bulk storage during execution.

Input/output (“I/O”) devices (including but not limited to keyboards 818, displays 824, pointing devices 820, other interface devices 822, etc.) can be coupled to the system either directly or through intervening I/O controllers or adapters (816, 826).

Network adapters may also be coupled to the system to enable the data processing system to become coupled to other data processing systems or remote printers or storage devices through intervening private or public networks (as shown generally at 832). Modems, cable modem attachments, wireless adapters, and Ethernet cards are just a few of the currently-available types of network adapters.

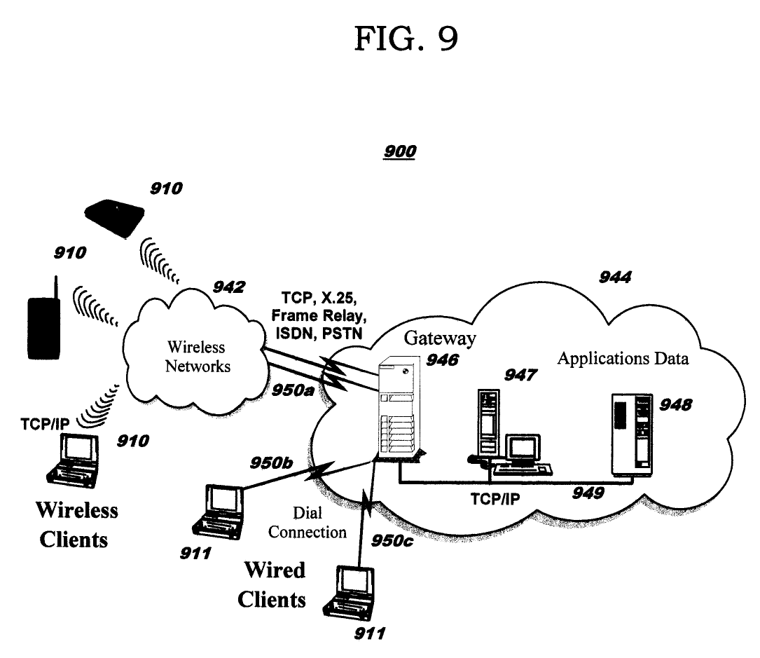

FIG. 9 illustrates a data processing network environment 900 in which the present invention may be practiced. The data processing network 900 may include a plurality of individual networks, such as wireless network 942 and network 944. A plurality of wireless devices 910 may communicate over wireless network 942, and a plurality of wired devices, shown in the figure (by way of illustration) as workstations 911, may communicate over network 944. Additionally, as those skilled in the art will appreciate, one or more local area networks (“LANs”) may be included (not shown), where a LAN may comprise a plurality of devices coupled to a host processor.

Still referring to FIG. 9, the networks 942 and 944 may also include mainframe computers or servers, such as a gateway computer 946 or application server 947 (which may access a data repository 948). A gateway computer 946 serves as a point of entry into each network, such as network 944. The gateway 946 may be preferably coupled to another network 942 by means of a communications link 950a. The gateway 946 may also be directly coupled to one or more workstations 911 using a communications link 950b, 950c, and/or may be indirectly coupled to such devices. The gateway computer 946 may be implemented utilizing an Enterprise Systems Architecture/390® computer available from IBM. Depending on the application, a midrange computer, such as an Application System/400® (also known as an AS/400®) may be employed. (“Enterprise Systems Architecture/390”, “Application System/400”, and “AS/400” are registered trademarks of IBM in the United States, other countries, or both.)

The gateway computer 946 may also be coupled 949 to a storage device (such as data repository 948).

Those skilled in the art will appreciate that the gateway computer 946 may be located a great geographic distance from the network 942, and similarly, the wireless devices 910 and/or workstations 911 may be located some distance from the networks 942 and 944, respectively. For example, the network 942 may be located in California, while the gateway 946 may be located in Texas, and one or more of the workstations 911 may be located in Florida. The wireless devices 910 may connect to the wireless network 942 using a networking protocol such as the Transmission Control Protocol/Internet Protocol (“TCP/IP”) over a number of alternative connection media, such as cellular phone, radio frequency networks, satellite networks, etc. The wireless network 942 preferably connects to the gateway 946 using a network connection 950a such as TCP or User Datagram Protocol (“UDP”) over IP, X.25, Frame Relay, Integrated Services Digital Network (“ISDN”), Public Switched Telephone Network (“PSTN”), etc. The workstations 911 may connect directly to the gateway 946 using dial connections 950b or 950c. Further, the wireless network 942 and network 944 may connect to one or more other networks (not shown), in an analogous manner to that depicted in FIG. 9.

The present invention has been described with reference to flow diagrams and/or block diagrams according to embodiments of the invention. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in the flow diagram flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flow diagram flow or flows and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flow diagram flow or flows and/or block diagram block or blocks.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention.

1. A computer-implemented method of personalizing meeting invitations for a meeting comprising a plurality of submeetings, comprising:
identifying, for each of the submeetings, each invitee invited to attend the submeeting;
identifying, for each of the submeetings, a time period corresponding to the submeeting; and
generating a personalized meeting invitation for each of the invitees, wherein the personalized meeting invitation corresponds to the submeeting which the invitee is invited to attend and reflects the time period corresponding to the submeeting.

2. The method according to claim 1, wherein the personalized meeting invitations are each configured to cause an electronic scheduling application to update an electronic schedule of the invitee to reflect the invitee as unavailable during the time period corresponding to the submeeting.

3. The method according to claim 1, further comprising:
sending the generated personalized meeting invitations to each of the invitees.

4. The method according to claim 1, wherein the identifying of the invitees further comprises programmatically consulting a data structure in which submeeting information is stored.

5. The method according to claim 1, wherein invitees are identified by a meeting originator who schedules the meeting.

6. The method according to claim 1, wherein the identifying each invitee further comprises indicating, for at least one of the submeetings, that at least one of the invitees is required to attend the submeeting and the generating reflects the required attendance of that invitee.

7. The method according to claim 1, wherein the identifying each invitee further comprises indicating, for at least one of the submeetings, that attendance of at least one of the invitees is optional for the submeeting and the generating reflects the optional attendance of that invitee.

8. The method according to claim 1, further comprising:
receiving, by at least one selected one of the invitees, the personalized meeting invitation generated for that invitee; and
updating, responsive to the receiving, an electronic schedule of the invitee to show the invitee as attending the submeeting during the corresponding time period.

9. The method according to claim 1, wherein a single meeting notice is created by a meeting originator that corresponds to the meeting and all of the submeetings.

10. The method according to claim 1, further comprising:
updating information pertaining to at least one of the submeetings;
generating revised personalized meeting invitations for each of the invitees of the at least one submeeting; and
sending the generated revised personalized meeting invitations to each of the invitees of the at least one submeeting.

11. The method according to claim 1, wherein at least one of the invitees is invited to attend more than one of the submeetings, and wherein the generating generates a separate personalized meeting invitation for the at least one invitee for each of the more than one of the submeetings.

12. The method according to claim 1, further comprising:
indicating, by a meeting originator, whether each of the invitees can view information for each of the submeetings and if so, enabling the invitees to view the information.

13. The method according to claim 1, wherein a markup language document fragment for each of the submeetings specifies information pertaining to the submeeting, the specified information comprising at least one of: a date of the submeeting, the time period corresponding to the submeeting, and a list of each invitee invited to attend the submeeting.

14. A personalized meeting invitation system in a computing environment connected to a network, comprising:
a meeting scheduler for scheduling a meeting, the meeting comprising a plurality of submeetings to which at least one invitee is invited to attend, each submeeting corresponding to a time period within an overall time period of the meeting;
persistent storage for storing, for each of the submeetings, an identification of at least one invitee invited to attend the submeeting;
a personalized meeting invitation generator for generating a personalized meeting invitation to invite each of the invitees to attend each of the submeetings during the corresponding time period for that submeeting; and
an invitation sender for sending the generated personalized meeting invitations to each of the invitees.

15. The system according to claim 14, wherein the personalized meeting invitations are each configured to cause an electronic calendaring application to update an electronic calendar of the invitee to reflect the invitee as unavailable during the time period corresponding to the submeeting.

16. The system according to claim 14, wherein the persistent storage identifies at least one of the invitees as being invited to attend more than one of the submeetings, and wherein the personalized meeting invitation generator generates a separate personalized meeting invitation for the at least one invitee for each of the more than one of the submeetings.

17. A computer program product for personalizing electronic meeting invitations for a meeting comprising a plurality of submeetings, the computer program product embodied on one or more computer-usable media and comprising computer-readable program code for:
identifying, for each of the submeetings, each invitee invited to attend the submeeting;
identifying, for each of the submeetings, a time period corresponding to the submeeting; and
generating a personalized meeting invitation for each of the invitees, wherein the personalized meeting invitation corresponds to the submeeting which the invitee is invited to attend and reflects the time period corresponding to the submeeting.

18. The computer program product according to claim 17, wherein the personalized meeting invitations are each configured to cause an electronic calendaring application to update an electronic calendar of the invitee to reflect the invitee as already scheduled during the time period corresponding to the submeeting.

19. The computer program product according to claim 17, further comprising computer-readable program code for:
sending the generated personalized meeting invitations to each of the invitees.

20. The computer program product according to claim 17, wherein:
the computer-readable program code for identifying each invitee further comprises computer-readable program code for indicating, for each of the submeetings, whether presence of each invitee invited to attend the submeeting is required or optional; and
the computer-readable program code for generating generates the personalized meeting invitations to reflect the required or optional attendance of each of the invitees.
